(19) United States
(12) Patent Application Publication
(10) Pub. No.: US 2009/0306814 A1
(43) Pub. Date: Dec. 10, 2009

(54) PRODUCE HANDLING EQUIPMENT WITH AIR EJECTION

(76) Inventor: Ian Robert Madden, Victoria (AU)

Correspondence Address: STITES & HARBISON PLLC, 1199 NORTH FAIRFAX STREET, SUITE 900, ALEXANDRIA, VA, 22314, US

(21) Appl. No.: 12/092,430

(22) PCT Filed: Oct. 5, 2006
(86) PCT No.: PCT/AU06/01461

§ 371 Date: Oct. 10, 2008

(30) Foreign Application Priority Data
Nov. 8, 2005 (AU) 2005906194

(51) Int. Cl. B07C 5/342; G06F 7/00

(52) U.S. Cl. 700/223; 209/644

(57) ABSTRACT

Produce sorting equipment comprising: a conveyor driving a plurality of carriers spaced along the conveyor to support a single produce between adjacent carriers; at least one exit conveyor positioned above the carriers; an air distribution sprocket positioned below at least two adjacent carriers, the sprocket being rotatable about an axis perpendicular to the conveying direction of the conveyor; the sprocket having a plurality of radial arms that terminate below the carriers; each arm including an air conduit; and means to control air flow along each air conduit; whereby as the sprocket rotates each arm passes underneath the carriers and an air blast via the conduit propels the produce supported by adjacent carriers up and off the carriers to fall onto the exit conveyor.

### FIELD OF THE INVENTION

This invention relates to produce handling and sorting equipment and in particular fruit handling equipment.

### BACKGROUND OF THE INVENTION

In conventional fruit handling equipment the fruit is transported along a conveyor and rotated past a photographic zone where the fruit is photographed and often weighed. The fruit is then ejected from the conveyor in response to signals emanating from a computer that analyses the photographic images of the fruit to determine size, colour, weight, blemish and like parameters. This equipment usually has means activated by the computer to cause fruit to be selectively ejected off the side of the conveyor for collection in appropriately positioned bins.

In some fruit handling equipment the fruit is transported in parallel rows. However the number and spacing of these rows is determined by the need to eject the fruit from the side.

With small fruit such as cherry or grape tomatoes there is a need for compact and highly efficient sorting equipment. A major problem with cherry or grape tomatoes is the occurrence of splitting. A split tomato is viewed as a reject item. The usual way of sorting cherry tomatoes is to pass the tomatoes along a long conveyor in many rows and use humans to carefully watch the tomatoes as they rotate along the conveyor and then manually remove the split product. A typical conveyor can involve the use of 20 personnel to check and remove reject product. This process is highly labour intensive and thus expensive and, over time, the efficiency of the personnel deteriorates.

Most fruit sorting equipment uses mechanical ejection means, usually electrically operated solenoids to cause a tilting action that ejects the fruit sideways off the conveyor. It has also been proposed to use carefully positioned air jets to eject small fruit, especially fruit like cherry tomatoes off the side of conveyors. The use of appropriately positioned air jets can reduce the likelihood of damage to the fruit in the ejection process.

It is these issues that have brought about the present invention.

### SUMMARY OF THE INVENTION

According to one aspect of the present invention there is provided produce sorting equipment comprising a conveyor driving a plurality of carriers spaced along the conveyor to support a single produce between adjacent carriers, at least one exit conveyor positioned above the carriers, an air distribution sprocket positioned below at least two of the carriers, the sprocket being rotatable about an axis perpendicular to the conveying direction of the conveyor, the sprocket having a plurality of radial arms that terminate below the carriers, each arm including an air conduit; and means to control air flow along each air conduit, the sprocket being positioned whereby as the sprocket rotates each arm passes underneath the carriers and an air blast via the conduit propels the produce supported by adjacent carriers up and off the carriers to fall onto the exit conveyor.

Preferably the carriers are axially rotatable rollers.

The sprocket may be rotated by contact with the rollers. Preferably the underside of the carriers engage a recess between the extremity of the arms so that an arm extends into the gap defined by adjacent rollers.

In a preferred embodiment, the exit conveyor extends at right angles to the conveyor.

In accordance with another aspect of the present invention there is provided an ejection system for produce handling equipment of the kind including a conveyor comprising a plurality of spaced carriers that convey produce past a viewing station which can detect a variety of parameters of the produce, the ejection system comprising a collector positioned adjacent at least two of the carriers, a rotatable sprocket positioned underneath the at least two carriers and connected to a source of compressed air, means to control release of the compressed air, the sprocket having a plurality of radially extending arms each including an air conduit whereby as the sprocket rotates under the carriers an air blast is released from the air conduit of at least one arm adjacent the produce to displace the produce off the rollers for collection in the collector.

### DESCRIPTION OF THE DRAWINGS

An embodiment of the present invention will now be described by way of example only with reference to the accompanying drawings in which:

FIG. 1 is a perspective view of produce handling equipment in accordance with one embodiment of the invention;

FIG. 2 is a side elevational view of an ejection station that forms part of the handling equipment;

FIG. 3 is an end elevational view of the ejection station;

FIG. 4 is a plan view of rollers at the ejection station; and

FIGS. 5a, b, c, d, and e shows an air ejection sprocket in five positions as it rotates through 30°.

### DESCRIPTION OF THE PREFERRED EMBODIMENT

The produce handling equipment illustrated in the accompanying drawings is specifically designed for use with cherry or grape tomatoes. However it is understood that this invention relates to a wide range of produce that has to be graded and sorted on the understanding that an air current can be used to eject the produce from the equipment.

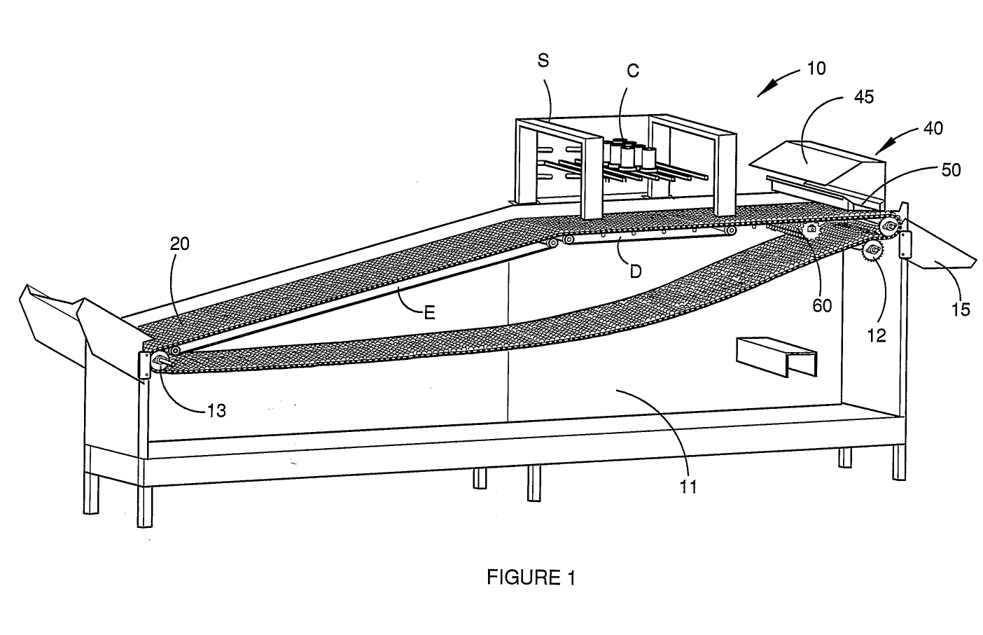

As shown in FIG. 1, the fruit handling equipment 10 or grader comprises an endless chain driven conveyor 11 that is supported between spaced drive sprockets 12, 13 mounted on a frame 15. The conveyor 11 comprises a plurality of plastics rollers 20 coaxially mounted on shafts 21 that extend in a parallel spaced array across the conveyor 11. The shafts 21 and rollers 20 are driven in a continuous loop to define the conveying surface.

In the embodiment shown in FIG. 1, sixteen rollers 20 are positioned on each shaft 21 thereby defining sixteen lanes of fruit.

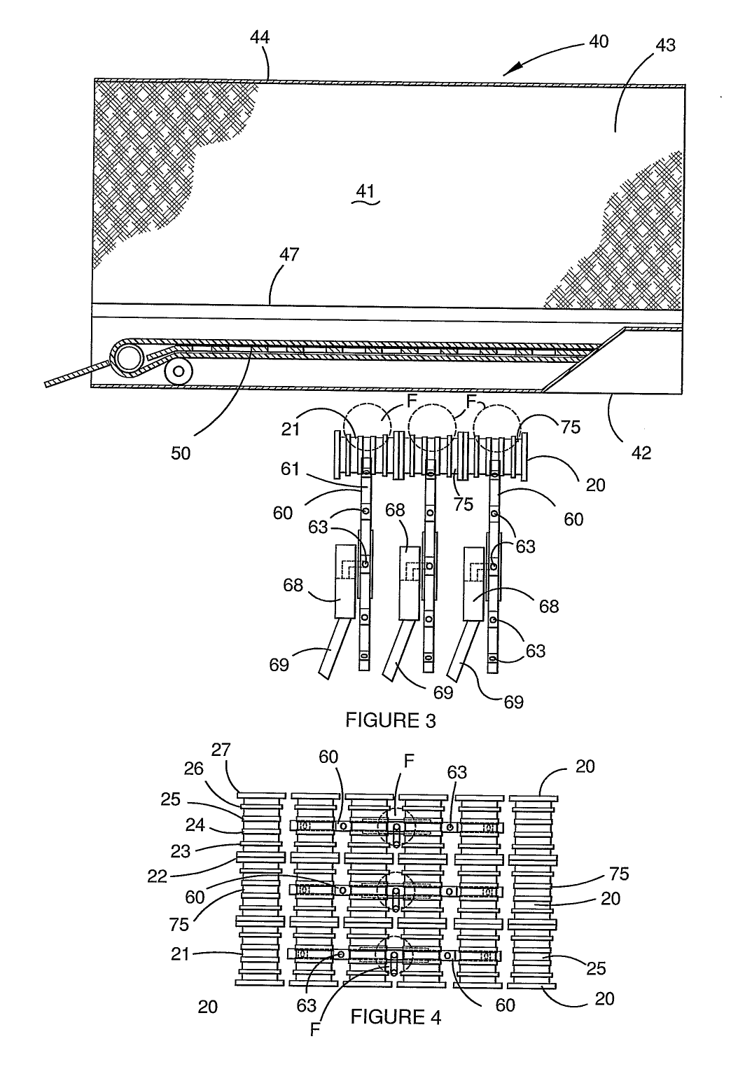

As shown in FIG. 4, each roller 20 is defined by the outer cylindrical surface of the shaft 21 and six spaced annular ribs 22-27. The outer ribs 22, 27 are slightly larger in diameter than the ribs 23, 26 whilst the centre ribs 24, 25 are the smallest in diameter. In use, The fruit (F) settles in the rib structure across adjacent rollers as shown in FIG. 3 and the ribs define grooves 75 therebetween.

The in-feed end E of the conveyor is inclined upwards at an angle of 90° to assist singulation of the fruit into individual indents between rollers 20. The fruit are transported in single file lines up an inclined slope to a viewing station S in which they pass under a series of cameras C. An auxiliary conveyor D is positioned under the conveyor at the viewing station to cause and control axial rotation of the rollers as they pass through the station. A similar auxiliary conveyor E is positioned under the inclined portion of the conveyor to encourage the fruit to assume sixteen lines. The rollers cause the fruit to rotate past the cameras C so that they can record images of the fruit. This information is fed to a computer (not shown) that can assess the size, colour, dimensions, and blemishes, especially splits, in the fruit, usually grape tomatoes. In a situation where the equipment is merely discarding cherry or grape tomatoes that contain splits, the computer will at the appropriate moment send a signal to ejection means 50 that will have the effect of ejecting the split tomato from the conveyor. The remaining tomatoes are collected off the end 15 of the conveyor for packaging.

Because there are sixteen closely spaced lanes it is not possible to effect sideways ejection of reject fruit. In this embodiment a mechanism has been incorporated that allows the rejected fruit to be ejected vertically off the conveyor 11. An air current is used to cause the rejected fruit to be propelled upwardly and forwardly in a parabolic path to be collected in a collector 40 positioned above the main conveyor 11. The collector 40 supports an exit conveyor 50 that is mounted perpendicularly to the direction of the main conveyor to thus transport the rejected fruit off the sides of the conveyor 11 at a plane above the level of the conveyor 11.

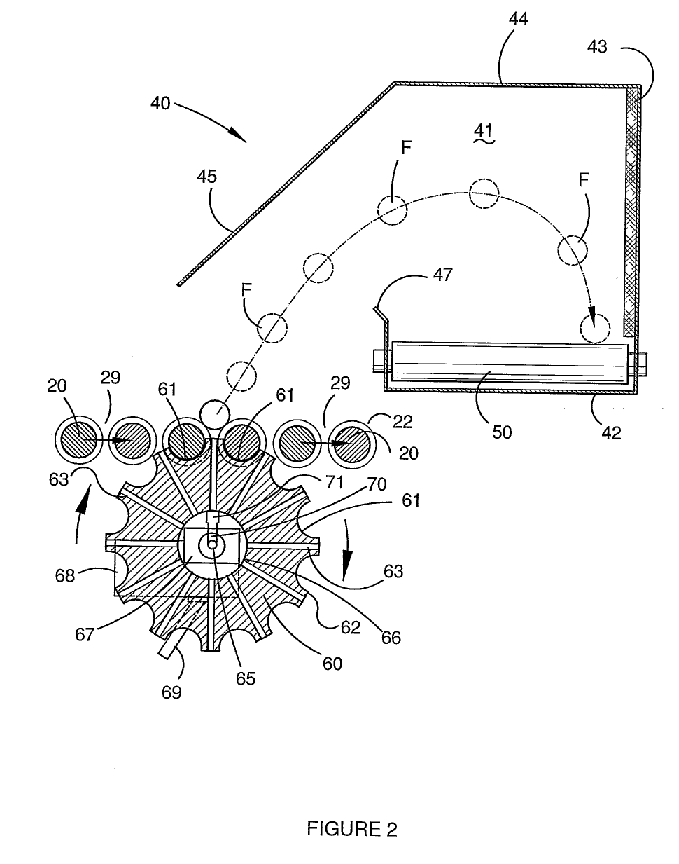

As shown in FIGS. 2 and 3 the collector 40 comprises a substantially rectangular enclosure 41 having a base 42 that supports the exit conveyor 50. A padded rear wall 43 extends vertically upwardly to join a roof 44 that has a downwardly inclined hood 45. The front of the enclosure defines an elongate opening 46 between the underside of the hood and an elongate lip 47 on one side of the exit conveyor 50. The lip 47 extends parallel to the exit conveyor 50 and transverse to the main conveyor 11. Also shown in FIG. 2, the hood 45 acts to deflect the parabolic path of the rejected fruit down onto the exit conveyor 50. In this way the hood 45 in combination with the lip 47 ensures that all rejected fruit lands on the exit conveyor 50 for removal.

It is understood that any number of exit stations can be provided on the conveyor downstream of the viewing station S and that in consequence, the computer can selectively reject fruit on a variety of different parameters such as size, shape, weight, blemish, or colour problems.

The mechanism for ejection of reject fruit is illustrated with particular reference to FIGS. 2 to 5. As shown in FIG. 2 there is a space 29 between adjacent rollers and the fruit sit across the space resting on the frusto conical ends 22, 23 of the rollers 20. The fruit are ejected by subjecting the fruit to a blast of pressurised air from the underside that has the effect of propelling the fruit upwardly. The forward motion of the conveyor 11 causes the fruit to be propelled upwardly and forwardly in a parabolic arc as shown in FIG. 2 to land in or engage the collector 40 for deflection onto the exit conveyor 50.

The blast of pressurised air is supplied via an air distribution sprocket 60 that has spaced semicircular recesses 61 in its outer periphery defining twelve radial arms 62 or teeth each of which has an air conduit 63 extending radially along the centre of the arm 62. The sprocket 60 is mounted on a shaft 65 below the rollers 20 at a specific position in which the undersides of two adjacent rollers sit within the semicircular recesses 61 so that the forward motion of the rollers 20 on the main conveyor 11 causes the sprocket 60 to axially rotate about the shaft 65 which has its axis perpendicular to the direction of the conveyor 11. At the position where the adjacent rollers 20 locate within adjacent recesses 61 the extremity of the radial arm 62 terminates at a position approximately half way up the roller 20. This is illustrated in FIG. 2. The recesses 61 separate the arms 62 that are inclined to each other through an angle of 30°.

The centre of the sprocket 60 has a hollow cylindrical chamber 66 that accommodates a fixed air reservoir 67 that is coupled to a solenoid valve 68 and air supply 69 from a compressor (not shown). The fixed reservoir 67 has a single radial exit 70 that merges into an enlarged plenum chamber 71 so that as the interior surface of the sprocket 60 rotates past the end of the plenum chamber 71, the plenum chamber 71 aligns up with a conduit 63 in the arm thus allowing air to flow from the reservoir 67 up through the conduit 63 against the underside of the fruit. The solenoid valve 68 controls release of the air on instruction from the computer so that compressed air can be released at the appropriate time and duration under the fruit to ensure vertical lift and ejection.

The fact that the sprocket 60 is driven by the rollers 20 means that the air jet moves in synchronisation with the rollers 20 which allows a nearly full pitch travel time for exposure to the air blast. This arrangement also has the advantage that the air jet is closer to the underside of the fruit than would be the case if a fixed air jet was simply positioned under the space between the rollers.

As described above the port timing on the sprocket 60 allows connection of the appropriate conduit 63 to the solenoid valve 68 but has no effect on air switching which is controlled by the solenoid valve 68. With a twelve arm sprocket 30° of angular rotation is available for each arm to be connected to the supply port 65 from the solenoid valve 68. The actual porting in the air reservoir 65 and rotating sprocket allow for 5° of overlap where two ports are simultaneously connected to the supply. By careful control of the solenoid timing the overlap region can be avoided leaving about 85% of the travel time available for ejection.

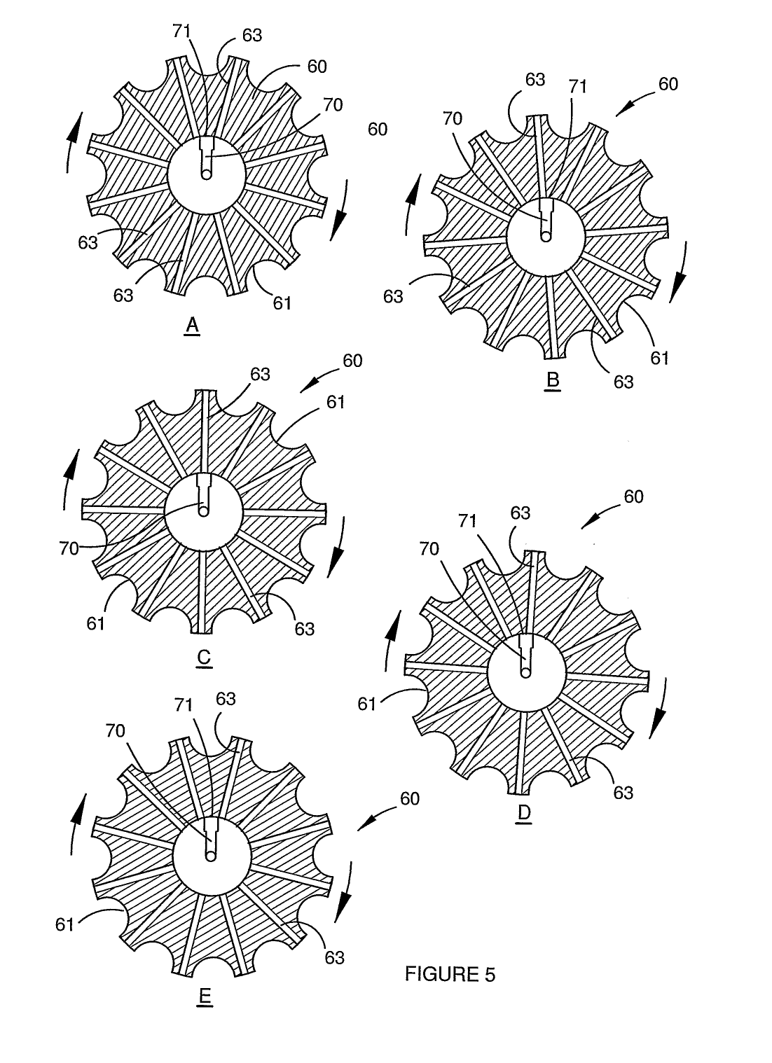

This timing feature is illustrated with reference to FIGS. 5a-e in which in FIG. 5a the air passage is just opening at 15° before vertical as previous air passage has just closed. In FIG. 5b the air passage is fully open at 7.5° before vertical. In FIG. 5c the air passage is fully open and vertical. In FIG. 5d the air passage is still fully open at 7.5° after vertical. Further rotation will cause air passage to start to close. In FIG. 5e the air passage is closed at 15° past vertical and next air passage starts to open and the sprocket 60 has rotated through 30°.

The unhindered terminal vertical height of ejection for varied fruit size is approximately inversely proportional to mass. Timing of the solenoid valve in accordance with a computer determined volume therefore mass given that the density of the fruit it substantially constant, can be used to control the trajectory of the fruit up to a full pitch for large fruit and proportionally shorter duration for smaller fruit.

Matching ejection trajectory for different fruit size minimises damage to the fruit by controlling impact velocities. It also ensures that the fruit are ejected in a known parabolic fashion to ensure collection by the collector for transfer to the exit conveyor.

The size of the sprocket 60 is of considerable importance. For smooth engagement with the rollers 20 of the conveyor the sprocket needs at least twelve teeth or arms 62 to meet the engineering requirements of a roller engaging the sprocket. The moving conveyor rollers drive the free wheeling sprocket and the rollers must stay meshed with the arms 62 of the sprocket 60 for successful ejection of the fruit. This feature has to be offset against the requirement to minimise the delivery port length and volume to maintain the rapid response times necessary for fruit ejection at high speed. With the chosen conveyor pitch of 31.75 mm to suit grape tomatoes the radial conduit length from hub to arm tip for a twelve arm sprocket is about 60 mm (the pitch circle diameter of the sprocket is 122 mm). Using a 2.5 mm to 3 mm conduit diameter the required flow and response time is acceptable for fruit from 1 to 30 grams with a 6 bar air pressure supply.

In research it has been discovered that placing a pressurised jet of air on the underside of fruit resting on rollers of the kind described above can, as the air rushes past the rollers and fruit, set up a venturi effect in which there is a vacuum formed on the underside of the fruit that draws the fruit against the roller instead of propelling it upwardly.

To reduce the ventui effect and thus reduce the air pressure necessary to eject the fruit the air space between the fruit and the cylindrical core of the rollers is kept as large as possible to keep the air velocity between the fruit and the rollers as low as possible.

The venturi effect is particularly critical with small fruit that sit lower in the gap between adjacent rollers. The tip of the arms 63 of the sprockets are positioned to just touch the underside of small fruit thus causing a slight wobble of the fruit causing an air gap that breaks down the venturi effect. With bigger fruit that sit higher in the gap, the grooves 75 between the ribs on the rollers 20 ensure entry of ambient air thus breaking down the vacuum.

A grader of the kind described above has the capacity for very efficiently ejecting reject fruit through use of a controlled air current and provides a totally automated system for eliminating split tomatoes without the need for human intervention.

1. Produce sorting equipment comprising:
a conveyor driving a plurality of carriers spaced along the conveyor to support a single produce between adjacent carriers;
at least one exit conveyor positioned above the carriers;
an air distribution sprocket positioned below at least two adjacent carriers, the sprocket being rotatable about an axis perpendicular to the conveying direction of the conveyor;
the sprocket having a plurality of radial arms that terminate below the carriers;
each arm including an air conduit; and
means to control air flow along each air conduit;
whereby as the sprocket rotates each arm passes underneath the carriers and an air blast via the conduit propels the produce supported by adjacent carriers up and off the carriers to fall onto the exit conveyor.

2. The produce sorting equipment according to claim 1, wherein the carriers are axially rotatable rollers.

3. The produce sorting equipment according to claim 2, wherein a plurality of rotatable rollers are co-axially mounted on a shaft to define a plurality of parallel lanes.

4. The produce sorting equipment according to claim 3, wherein each lane has a sprocket positioned under each roller.

5. The produce sorting equipment according to claim 3, wherein each roller comprises a series of axially spaced annular ribs projecting radially from the shaft.

6. The produce sorting equipment according to claim 5, wherein the ribs define grooves therebetween and the produce sits across the ribs.

7. The produce sorting equipment according to claim 1, wherein the exit conveyor is positioned in the proximity of the sprocket, the exit conveyor supporting a collector that ensures that produce propelled off the conveyor falls onto the exit conveyor.

8. The produce handling equipment according to claim 7, wherein the collector comprises at least one deflecting wall that if engaged by the product deflects the produce onto the conveyor.

9. The produce handling equipment according to claim 1, wherein the exit conveyor is mounted with its conveying direction mutually perpendicular to the conveying direction of the conveyor.

10. The produce handling equipment according to claim 1, wherein the sprocket is rotated by contact with the carriers.

11. The produce handling equipment according to claim 10, wherein the underside of the carriers engage a recess between the extremity of the arms so that an arm extends into the gap defined by adjacent carriers.

12. The produce handling equipment according to claim 10, wherein a semi circular recess is positioned between each arm, the semi circular recess engaging the underside of adjacent carriers so that movement of the carriers in the conveying direction causes rotation of the sprocket.

13. The produce handling equipment according to claim 1, wherein each conduit extends radially into a chamber positioned centrally of the sprocket, an air supply pipe extends axially into the chamber and has a fixed radially extending outlet port that terminates at the wall of the chamber so that as the sprocket rotates each conduit moves past the outlet port.

14. The produce handling equipment according to claim 13, wherein a solenoid valve controls release of compressed air from the outlet port as the conduit moves past the port.

15. The produce handling equipment according to claim 14, wherein the timing of the solenoid valve is controlled by a computer, whereby the computer controls the duration of the release of compressed air dependent on the weight of the produce.

16. The produce handling equipment according to claim 1, wherein each sprocket has twelve equally spaced arms and the porting of the air supply allows potential release of compressed air along a conduit through 30° rotation of the sprocket.

17. An ejection system for produce handing equipment of the kind including a conveyor comprising a plurality of spaced carriers that convey produce past a viewing station which can detect various parameters of the produce, the ejection system comprising:
a collector positioned adjacent at least two of the carriers;
a rotatable sprocket positioned underneath the at least two carriers and connected to a source of compressed air;
means to control release of the compressed air;
the sprocket having a plurality of radially extending arms each including an air conduit whereby as the sprocket rotates under the carriers an air blast is released from the air conduit of at least one arm adjacent the produce to displace the produce off the rollers for collection in the collector.

18. The ejection system according to claim 17, wherein the viewing station includes a camera that takes pictures of the produce as it passes through the station, the camera being coupled to a computer which is in turn coupled to the means to control release of compressed air whereby the timing and direction of the release of compressed air is determined relative to the calculated mass of the produce.

19. The ejection system according to claim 17, wherein the carriers engage the sprocket to cause rotation of the sprocket to ensure synchronization between rotation of the sprocket and the conveying speed of the produce.

20. The ejection system according to claim 17, wherein the collector is an exit conveyor positioned above the conveyor.
